(19) United States
(12) Patent Application Publication
(10) Pub. No.: US 2005/0153014 A1
(43) Pub. Date: Jul. 14, 2005

(54) Creamy alcoholic beverages and methods for making same

(76) Inventors: William F. Farnham, Canandaigua, NY (US); Marilyn A. Konopka, Canandaigua, NY (US); Anil J. Shrikhande, Madera, CA (US)

Correspondence Address: KENYON & KENYON, ONE BROADWAY, NEW YORK, NY, 10004, US

(21) Appl. No.: 10/754,209

(22) Filed: Jan. 9, 2004

(51) Int. Cl. C12C 11/00

(52) U.S. Cl. 426/11

(57) ABSTRACT

The invention is directed to creamy alcoholic beverages comprising wine and/or spirits and creamer, wherein the creamer is emulsified within the wine and/or spirit and the creamy alcoholic beverage is storage stable at a temperature of about 20° C. to about 25° C. for at least one year. Optionally, the creamy alcoholic beverage may include pectin and does not excessively foam. The wine may be treated to substantially remove or deactivate proteolytic enzymes within the wine using at least one of heat treatment, column adsorption, clay adsorption, tangential filtration, or ultra-filtration.

### FIELD OF THE INVENTION

The field of the invention encompasses creamy alcoholic beverages, which may be mixed or homogenized to a fine consistency as a creamy opaque emulsion, of beverage grade alcohol and acidic cream base which may be blended with ice, are stable at a pH of about 3 to about 5, and may be stored at ambient temperature for about a year. Also, the invention encompasses methods of producing creamy alcoholic beverages.

### BACKGROUND OF THE INVENTION

Cream based alcoholic liqueurs have been marketed for nearly two decades and have appealed to the public since their introduction. Consequently, the beverages have been introduced with greater and greater frequency into the marketplace. Creamy alcoholic beverages or liqueurs can be prepared on the spot, for immediate consumption, by adding milk or cream to an alcoholic beverage. Such creamy alcoholic beverages include milk punch, Alexander, Pink Squirrel, Golden Cadillac, Irish Alexander, Amaretto Cream, and Grasshopper. The beverage is mixed thoroughly by shaking the drink in a shaker, however, separation is likely to occur upon standing for a period of time, such as one half hour, developing separate fat and water phases, thus, rendering the drink unpalatable. Creamy alcoholic beverages or liqueurs can also be prepared for commercial distribution and delayed consumption. Such prepared creamy beverages and liquors must be sufficiently stable to survive ordinary conditions of commercial distribution. The liqueurs typically contain a dairy base, caramel color, and flavors such as vanilla, chocolate, or coffee and an alcohol content of 17% to 20% by volume. The alcoholic drinks or liqueurs are neutral with a pH of about 6.5 to 7. Such cream based alcoholic liqueurs have become very popular as dessert drinks due to their high alcohol content and flavors often associated with desserts. Such cream based alcoholic beverages have a neutral pH of around 7 and are based upon neutral alcohols such as alcoholic spirits. Such neutral cream based alcoholic beverages typically contain a large amount of carbohydrates and no protein, which increases caloric intake while decreasing the desirable organoleptic properties of the beverage.

Acidic cream based alcoholic beverages have been reported. The use of readily available additives, which provide the creamy appearance to the cream based alcoholic beverages, which contain milk proteins can cause problems in acidic beverages due to instability and/or degradation of milk fat and/or proteins. The greater the acidity level, the greater the amount of fat and protein agglomeration, which in turn yields a beverage of undesirable appearance and taste. The beverages can appear lumpy, an unappealing characteristic to the consuming public. The agglomeration is typical at pH levels below 6, especially in the pH range from 3 to 5. Wines are such acidic beverages typically having a pH of between 3 and 5 with which conventional cream bases may lead to instability and degradation.

Such instability of creamy liqueurs may cause other problems: the viscosity can increase to such an extent that the liqueur gels and is unpourable. Creamy liqueurs may develop a cream or froth caused by separation of the fats within the liquid. A fatty layer may form on top of the bulk of the beverage or at the bottom. Solids may precipitate; and sedimentation may occur as a fat collar forms at the neck or bottom of a bottle. The instability of creamy liqueurs affects color and flavor as the dairy ingredients degrade over time. Several attempts to overcome the deficiencies have met with mixed results.

The instability of creamy liqueurs has been addressed by the careful selection of emulsifiers, antioxidants, thickeners and stabilizers, or by heating and homogenizing the ingredients of the cream liqueur. However, a cream liqueur is a very complicated colloidal system with many interacting factors. Addition of alcohol or an alcoholic beverage to dairy or non-dairy creamers can change the characteristics of the aqueous phase. Protein micelles stable in water may become destabilized and in turn, destabilize the fat emulsion. The acidity of the alcoholic beverage may cause fats to agglomerate and the milk proteins to degrade, further deteriorating the beverage.

U.S. Pat. No. 4,331,689 to G. A. Shemwell, purports to solve the problem of making a stable creamy wine-based, acidic beverage, by using a protein-free creamer. Shemwell's creamer is a dried protein free fat emulsion concentrate that forms an oil-in-water emulsion and is stable in the presence of a relatively high alcohol concentration and a relatively high acidity such as is found in wine. To achieve the dried emulsion concentrate, a major proportion, 57 to 65% by weight, of the concentrate must be a water soluble carbohydrate, such as corn syrup solids, to act as a carrier for the fat and to provide flavor. The novel dried fat protein free emulsion product may be combined with wine to produce a wine based beverage having a creamy appearance and creamy mouthfeel.

U.S. Pat. No. 5,066,509 to van den Hoven et al., relates to a method of stabilizing creamy alcoholic beverages based on cream, yogurt, or other dairy products. Van den Hoven describes problems of stability of known creamy alcoholic beverages, in particular the problems which can result from the presence of proteins in beverages with reduced pH, and which may be exacerbated by heating such beverages to kill undesirable microorganisms or bacteria present in the cream and yogurt. Van den Hoven teaches that it is conventional to add artificial cream stabilizer such as pectin or carboxymethyl cellulose to stabilize emulsions. Van den Hoven proposes to solve the stability problem by replacing conventional fats in a creamer with medium chain triglycerides (MCTs), which contain saturated fatty acids with 6 to 12 carbon atoms. However, Van den Hoven describes only one wine-based creamy beverage, (example C, table III) a protein-free beverage containing only MCT as an emulsifier.

U.S. Pat. No. 4,419,378 to C. E. Rule relates to a homogenized cream/alcohol-containing beverage comprises cream or milk, alcohol, and a high HLB emulsifier selected from the group consisting of high HLB polyglycerol esters of fatty acids, ethoxylated fatty acid esters; and sugar esters, each in an emulsifying amount. The beverages typically use heavy cream-containing beverages which are 34 proof, i.e., having about 17% alcohol, however, no mention is made about combining the emulsions with wine or beverage stability at low pH.

EP 177,077 relates to sour milk based alcoholic beverages prepared by making a soured milk product having at least 4% milk fat and mixing the soured milk with flavor ingredients such as fruit juice, essence, or concentrate with thickening or stabilizing agents. The beverage is homogenized in two stages and heat treated, followed by addition of deaerated alcohol. The beverages may have a pH value between 3.5 and 5.

Although the prior art discloses several soured milk alcoholic beverages and wine based beverages, the prior art does not disclose a creamy wine based beverage that contains proteins. We have now discovered that stable creamy wine based beverages with improved organoleptic properties may be prepared using conventional protein-containing creamers containing pectin stabilizers if the wine is treated to prevent proteolytic cleavage of the pectin. In addition, such creamy wine based beverages can be blended with ice to produce attractive drinks without excessive frothing or foaming (we use the term “non-foaming” below to refer to compositions which show substantially no foaming or frothing). We have also discovered that creamy alcoholic spirits having reduced pH in the range of about 3 to about 5 may be prepared using such creamers.

### SUMMARY OF THE INVENTION

One embodiment of the invention encompasses a wine-based alcoholic beverage comprising a stable non-foaming opaque emulsion of at least one wine substantially free of proteolytic enzymes, such as a heat treated wine; and at least one protein-containing creamer in sufficient amount to form a stable emulsion. The heat treated wine may be heat treated at a temperature from about 120° F. to about 250° F., for between about 1 minute and 2 hours. The wine-based alcoholic beverage may have a pH from about 3 to about 5. The creamer may be at least one of a dairy creamer or a non-dairy creamer. The wine-based alcoholic beverage may further comprise pectin.

Another embodiment of the invention encompasses a spirit-based alcoholic beverage comprising a stable non-foaming creamy opaque emulsion of at least one spirit; and at least one neutral-tasting protein-containing creamer in sufficient amount to form a stable emulsion. The spirit-based alcoholic beverage may have a pH from about 3 to about 5 and optionally, further comprise pectin.

Yet another embodiment of the invention encompasses processes for making wine-based alcoholic beverages comprising treating a wine to substantially remove or deactivate proteolytic enzymes; forming a first blend of at least one wine substantially free of proteolytic enzymes and at least one non-foaming protein-containing neutral-tasting creamer; emulsifying the mixture to form a stable, non-foaming, creamy, opaque, wine based alcoholic beverage, having a pH between about 3 and about 5. The wine may be heat treated to substantially remove or deactivate proteolytic enzymes by heating the wine to a temperature of about 120° F. to about 250° F. for about one 1 minute to about 2 hours. The process may further comprise adding a second blend of at least one wine substantially free of proteolytic enzymes, alcoholic spirits, and/or fruit juice to the first blend; and combining the first blend and the second blend in a proportion sufficient to obtain final blend of an emulsified wine-based alcoholic beverage. The process may further comprise a step of acidifying the second blend to obtain a final blend with a pH of about 3 to about 5. In the process, the first blend has a wine to creamer ratio of 1:1 by volume, and/or the final blend comprises 30% to 35% by volume of the first blend and 65% to 70% by volume of the second blend.

One embodiment of the invention encompasses processes for making spirit-based alcoholic beverages comprising emulsifying a first blend of at least one spirit and a sufficient amount of at least one protein-containing neutral-tasting creamer to form a stable emulsion; mixing a second blend of at least one sprit and/or flavors; and combining the first blend and the second blend in a proportion sufficient to obtain a final blend of an emulsified spirit-based alcoholic beverage. The creamer may further comprise pectin. The process may further comprise a step of acidifying the second blend to obtain a final blend with a pH of about 3 to about 5. The final blend may comprise 30% to 35% by volume of the first blend and 65% to 70% by volume of the second blend.

Another embodiment of the invention encompasses processes for making a stable, spirit based non-foaming acidic alcoholic beverage comprising blending a non-acidic spirit and a protein-containing non-foaming creamer; optionally adding other spirits and/or flavors; adjusting the pH of the blend to between about 3 and about 5; and emulsifying the blend to form a stable, spirit based non-foaming alcoholic beverage having a pH between about 3 and about 5.

### DETAILED DESCRIPTION OF THE INVENTION

The present invention encompasses formulations of acidic cream based alcoholic beverages with a variety of exotic fruit flavors and the methods of making thereof. Acidic creamy products can be consumed as such or blended with ice to provide blender drinks. The formulations of the invention stabilize acidified cream based alcoholic beverages at low pH and provide stable emulsions which will not foam upon blending with ice or water.

Protein containing creamers are well known, and commercially available. Such creamers, when mixed with an aqueous solution, like coffee, form an oil-in-water emulsion with desirable organoleptic properties, i.e., they feel good in the mouth.

It was known that emulsions formed from such protein containing creamers may require stabilization to prevent the agglomeration, flocculation, or precipitation of the proteins; thus, destroying the emulsion. Known stabilizers included polyethylene glycol alginate, carboxymethylcellulose, and pectin.

Wine is acidic; it has a pH of between about 3 and about 5. Alcohol and low pHs either alone or in combination are known to destabilize oil-in-water emulsions. The prior art teaches that acidic wine emulsions can be stabilized by using non-protein-containing creamers, thus preventing the problem of protein agglomeration, flocculation or precipitation by removing the protein component.

We, however, have found that stable emulsions of wine and protein containing creamers stabilized with polyethylene glycol alginate can be prepared. However, when blended with ice in a conventional blender, as might be used in a bar, such creamy wine-based beverages, foamed excessively. The amount of foam made the beverage unappealing to the consumer and/or difficult to drink. Although pectin was known as a stabilizer for protein-containing emulsions, it was thought that pectin was unsuitable for a wine based beverage, because wine contains proteolytic enzymes which degrade pectin, preventing it from stabilizing the emulsion, and thus lead to an unstable emulsion. We found that by suitably pre-treating the wine to deactivate or remove proteolytic enzymes, without substantially affecting the taste of the wine, pectin-stabilized wine-based emulsions could be prepared which were stable, which did not suffer from the disadvantages of other stabilizers, and that pectin-stabilized protein-containing creamers could be advantageously used to make stable creamy wine-based beverages which did not excessively foam when blended with ice. Therefore, the present invention is directed, in part, to pectin stabilized wine creamer beverages which when blended do not excessively foam.

The present invention encompasses alcoholic beverages which combine the rich texture of cream based beverages with the flavor and alcohol content of wines and/or spirits. In particular, the invention is directed to creamy opaque non-foaming alcoholic beverages having a pH of about 3 to about 5 and are capable of being blended. The creamy alcoholic beverages may be stable for about a year when stored either under refrigeration or at ambient temperature (a temperature of about 20° C. to about 25° C.). The invention encompasses methods of preparing the creamy alcoholic beverages.

The beverages of the invention comprise wine substantially free of proteolytic enzymes and/or spirits and at least one creamer. Optionally, the beverages may include additional ingredients such as those commonly known in the art including, but not limited to, sweeteners, fruit flavors, flavoring agents, coloring agents, thickeners/stabilizers, emulsifiers, preservatives, and the like.

The wine used in the beverage of the invention may be any wine substantially free of proteolytic enzymes. As used herein, the term “substantially free of proteolytic enzymes” refers to wines or fruit juices wherein the proteolytic enzymes have been removed or deactivated such that they do not substantially degrade proteins. In one embodiment of the invention, wine is first produced by expressing the juice from white grape varieties. White grape varieties may include grape varieties commonly used in wine making including, but are not limited to, Vitis Vinifera or Vitis Labrusca. To make the wine, the juice is fermented with yeast to about 10% to about 14% alcohol content by volume. Subsequently, the wine is chilled to about 30° F. to settle unstable tartrates. In another embodiment, red wines from varietal grapes can be produced by thermal vinification of grapes at a temperature of about 120° F. to about 150° F. to release the color from skin. The juice is separated and subsequently, fermented to red wine. Alternatively, red grapes may be crushed and fermented on the skin and seeds. The resulting red wines are separated from skins and seeds, chilled to 30° F. for tartrate stabilization. Other fruit wines may be used including wines produced from apple, pear, citrus, tomato, blackberry, elderberry, loganberry, and peach, among others.

The wine is treated prior to adding the creamer to deactivate proteolytic enzymes which may cause milk protein agglomeration and/or affect fat emulsions. In particular, the wine must be treated to deactivate or remove the proteolytic enzymes commonly associated with wine. Methods commonly known in the art may be used for deactivating or removing the proteolytic enzymes including, but are not limited to, at least one of heat treatment, column adsorption, clay adsorption, tangential filtration, or ultra-filtration. The methods may be used individually or in combination depending upon the amount of wine and other variables apparent to one of ordinary skill in the art. As used herein, the term “deactivating” as applied to enzymes refers to the reduction in enzymatic activity to a level sufficient to reduce visible protein agglomeration. As used herein, the term “remove” as applied to proteolytic enzymes refers to the removal of proteolytic enzymes to a level sufficient to reduce visible protein agglomeration.

In one method, to denature proteolytic matter in the wine, the wine is heated to a temperature sufficient to denature proteolytic matter. The wine may be heated under pressure if desired. Typically, the wine is heated to a temperature of about 120° F. to about 250° F. for about 1 minute to about 2 hours. Preferably, the wine is heated to a temperature of about 140° F. to about 212° F. for about 1 to about 15 minutes. The wine may be heated at atmospheric pressure, or super-atmospheric pressure. The heat treated wine is polished filtered using diatomaceous earth, or any other depth filters and then filtered through 0.45 micron filter to remove microbiological species such as yeast, mold, bacteria, etc.

The wine may be treated by other methods known in the art to remove proteolytic enzymes, including centrifugation, filtration, column adsorption, clay adsorption, tangential filtration, or ultra-filtration.

Alternatively, in one embodiment the wine used in the beverage of the invention may be made from a fruit juice substantially free of proteolytic enzymes that is subsequently fermented into wine. The fruit juice may be made using methods commonly known in the art, such as the methods described above for wine making. Subsequently, the fruit juice must be treated to deactivate or remove the proteolytic enzymes commonly associated with fruit juice. Methods commonly known in the art may be used for deactivating or removing the proteolytic enzymes such as those described above for wine.

Spirits used in the alcoholic beverage of the invention include, but are not limited to, at least one of whiskey, rum, brandy, bourbon, cognac, tequila, vodka, or gin.

The creamers used in the beverage of the invention may be dairy or non-dairy creamers. Preferably, the creamer has a neutral flavor and/or is acidic. More preferably, the creamer contains pectin. Dairy creamers usually contain milk proteins and milk fat. Non-dairy creamers typically contain at least one non-dairy fat such as coconut oil, partially or fully hydrogenated vegetable fats, palm kernel oil, cottonseed oil, corn oil, soybean oil, or peanut oil. However, both dairy and non-dairy creamers typically contain at least one protein. Dairy creamers include, but are not limited to, at least one of cream, milk, butterfat, skim milk, concentrated low-fat milk, milk powder, whey protein products, milk protein concentrates, or casein protein-containing products. Preferably, the creamer contains pectin. More preferably, the creamer is an acidic non-dairy base sold under the product numbers 80083 Creamy Creation (Batavia, N.Y.). The proprietary acidic non-dairy base comprises a dairy protein source, such as milk, a vegetable fat, stabilizers consisting of gums, carbohydrates, emulsifiers, acidulant, etc., and is adjusted to a pH range of 3.5 to 5.0. Typically, the amount of creamer will depend on whether wine or spirits is used in the creamy alcoholic beverage. When wines are used, typically the creamer is present in an amount of about 15% to about 17.5% by volume. When spirits are used, typically the creamer is present in an amount of about 20% to 25% by volume. In one method for preparing the creamy alcoholic beverage of the invention, a 50:50 blend of wine and creamer is prepared, which is subsequently mixed with other wine containing blends. Naturally, dairy concentrates may be added in smaller amounts.

The fruit flavors may be conventional fruit flavors such as those commonly used in beverages. The fruit flavors can be used in pure form such as fruit juices, concentrates, alcoholic fruit extracts, or combinations thereof and can be natural and/or artificial. Suitable fruit flavors include, but are not limited to, at least one of apple, blackberry, cherry, citrus, cranberry, elderberry, guava, kiwi, lemon, lime, loganberry, mango, mint, peach, pear, pineapple, plum, raspberry, strawberry, tomato, exotic fruits, or tropical fruits.

Typically, the alcohol content of the beverage is between 0.5% and 30% by volume of the total beverage. The alcohol content may depend on whether the creamy alcoholic beverage is wine based or spirit based. If wines are used, then typically the alcohol content is from about 12% to about 13.5% by volume. If spirits are used, then typically alcohol content is from about 12% to about 18.5% by volume. If necessary, the creamy alcoholic beverage can be fortified to the desired alcohol range using distilled spirits, neutral grain spirits, grape spirits, alcohol, and the like.

The creamy wine based beverage according to the invention may further comprise aromatic and flavoring substances, carbohydrates, dextrose syrup or maltodextrins, natural or artificial sweeteners, and natural or artificial coloring substances.

When formulating the beverage of the invention, typically the acidity can be adjusted to a preferred range of a pH of about 3 to about 5. In wine, the acidity can be adjusted by neutralizing the acid by a suitable use of alkaline compounds. Alkaline compounds include, but are not limited to, hydroxide, carbonate, or bicarbonate bases or salts. Alternatively, the wine could be treated with anion exchange to yield a pH in the range of about 3 to about 5. The acidity of spirits formulated creamy alcoholic beverages can be adjusted with any of the food grade acids including, but not limited to, at least one of tartaric acid, malic acid, citric acid, phosphoric acid, and the like.

The creamy alcoholic beverage according to the invention can be prepared in any conventional manner as known to one of ordinary skill in the art. Typically, the ingredients of wine and/or spirits, creamer, and other optional ingredients are mixed together to form an emulsion of creamer within the wine. Preferably, the wine is treated to remove or inactivate proteolytic enzymes.

In one method, two blends are mixed to achieve the desired proportion of alcohol and beverage creaminess. A first blend, a fortified wine and/or spirit blend, comprises wine substantially free of proteolytic enzymes and/or spirits and creamer. A second blend comprises wine substantially free of proteolytic enzymes and/or spirits, sweeteners, natural and/or artificial flavors, natural and/or artificial colors, preservatives, and other optional ingredients. Thereafter, proportions of the first and second blend are mixed to achieve a final blend of the desired creamy alcoholic beverage. Typically, the final blend comprises 30% to 35% by volume of the first blend and 65% to 70% by volume of the second blend.

Having described the invention with reference to certain preferred embodiments, other embodiments will become apparent to one skilled in the art from consideration of the specification. The invention is further defined by reference to the following examples describing in detail the preparation of the composition and methods of use of the invention. It will be apparent to those skilled in the art that many modifications, both to materials and methods, may be practiced without departing from the scope of the invention.

### EXAMPLES

### Example 1

### Fruit Flavored Wine Blender

A first blend is prepared by fermenting grape wine to less than 14% alcohol by volume, and then heat treating to a temperature of 140° F. to 212° F. for a time of 1 to 15 minutes for protein stabilization. Subsequently, the wine is polish filtered and filtered with a 0.45 micron filter for microbiological stability. The total acidity is adjusted to a pH range of 3.5 to 3.8 by neutralizing the acid with a suitable alkaline compound such as salts of carbonate, bicarbonates and hydroxides. The grape wine (500-600 gallons) is fortified with grape spirits to an alcohol range of 23% to 23.9% alcohol by volume. The fortified grape wine is blended with acidified non-dairy base supplied by Creamy Creation in approximately a 50/50 ratio by volume.

A second blend is prepared by mixing 400 to 500 gallons grape wine, proteolytically deactivated and pH adjusted as described above, 100 to 300 gallons sweeteners, 1.3 to 16.7 gallons natural and/or natural and artificial flavors, natural and/or artificial colors, and preservatives (including potassium benzoate, potassium sorbate and potassium metabisulfite and any others deemed necessary within legal limitations).

The first and second wine blends are combined with gentle agitation under sanitary conditions. The fortified grape wine/acidified non-dairy base is used at approximately 30% to 35% by volume, and the flavored wine portion is used at approximately 65-70%. Composition of the final product will be have the following specifications alcohol 12.0% to 13.5% v/v; brix 17.5 to 23.0; and pH of 3.0 to 4.0.

### Example 2

### 1000 Gallon Batch of a Blender Drink Made with Rum and Acidified Non-Dairy Base

To form a first premix, 300-400 gallons of 80 proof beverage quality rum is blended with 600-700 gallons acid non-dairy base using gentle agitation. A second premix is formed by blending 400-500 gallons of 80 proof beverage quality rum, 0-50 gallons neutral grain spirits, 0-25 gallons water, and 0-325 gallons sugar in a separate tank. Natural flavors, natural and artificial flavors, caramel color, and other natural and artificial colors may be added as necessary. The first and second premixes are blended together using gentle agitation. The first premix is used at 30-35% by volume and the second is used at 65-70% by volume. The composition of the final product will be have alcohol in 12.0% to 18.5% by volume; brix 14.5 to 23.0; and a pH of 3.0 to 5.0.

### Example 3

### 1000 Gallon Batch of a Blender Drink Made with Grape Wine and Acidified Dairy Base

A first blend is made by fermenting grape wine to less than 14% alcohol v/v, and then heat treating from 140° F. to 212° F. for 1 to 15 minutes for protein stabilization. The wine is polish filtered and then filtered with a 0.45 micron filter for microbiological stability. The total acidity is adjusted to a preferred pH range of 3.5 to 3.8 by neutralizing the acid with alkaline compounds such as potassium carbonate. 500-600 gallons of the grape wine is fortified with grape wine spirits to an alcohol range of 23% to 23.9% alcohol v/v. The fortified grape wine is blended with acidified dairy base in approximately a 50/50 ratio.

A second blend is made by mixing 400 to 500 gallons grape wine, proteolytically deactivated and pH adjusted as described above, 100 to 300 gallons sweeteners, 0.3 to 35.7 gallons natural and/or natural and artificial flavors, natural and/or artificial colors, and preservatives (including potassium benzoate, potassium sorbate and potassium metabisulfite and any others deemed necessary within legal limitations).

The two grape wine blends are combined with gentle agitation under sterile conditions. The first blend, a fortified grape wine/acidified dairy base, is used at approximately 30% to 35% by volume, and the second blend, a flavored grape wine portion, is used at approximately 65% to 70% by volume. Composition of the final product will have alcohol from 12.0% to 13.5% v/v; brix 17.5 to 23.0; and a pH in the range of 3.0 to 5.0.

### Example 4

### 1000 Gallon Batch of a Blender Drink Made with Distilled Spirits and Acidified Non-Dairy Base

A first premix is made by blending 300-400 gallons of 80 proof beverage quality distilled spirits with 600-700 gallons acid non-dairy base using gentle agitation. Distilled spirits to include, but are not limited to, whiskey, rum, brandy, gin, vodka, and tequila. A second premix is made by blending 400-500 gallons of 80 proof beverage quality distilled spirits, 0-50 gallons neutral grain spirits, 0-25 gallons water, and 0-325 gallons sugar in a separate tank. Natural flavors, natural and artificial flavors, caramel color, and other natural and natural and artificial colors may be added as necessary. The first and second premixes are blended together using gentle agitation. The first premix is used at 30% to 35% by volume, and the second premix is used at 65% to 70% by volume. The composition of the final product will have alcohol 12.0% to 18.5% by volume; brix 14.5 to 23.0; and a pH in the range of 3.0 to 5.0.

### Example 5

### 1000 Gallon Batch of a Blender Drink Made with Distilled Spirits and Acidified Dairy Base

A first premix is made by blending 300-400 gallons of 80 proof beverage quality distilled spirits with 600-700 gallons acidified dairy base using gentle agitation. Distilled Spirits to include, but are not limited to, whiskey, rum, brandy, gin, vodka, and tequila. A second premix is made by blending 400-500 gallons of 80 proof beverage quality distilled spirits, 0-50 gallons neutral grain spirits, 0-25 gallons water, and 0-325 gallons sugar are in a separate tank. Natural flavors, natural and artificial flavors, caramel color, and other natural and natural and artificial colors may be added as necessary. The first and second premixes are blended together using gentle agitation. The first premix is used at 30% to 35% by volume, and the second premix is used at 65% to 70% by volume. The composition of the final product will have alcohol 12.0% to 18.5% by volume; brix 14.5 to 23.0; and a pH range of 3.0-5.0

### Example 6

### 1000 Gallon Batch of a Blender Drink Made with Fruit Wine (Other than Grape) and Acidified Non-Dairy Base

A first blend is made by fermenting fruit wine fermented to less than 14% alcohol v/v, and heat treating the wine from 140° F. to 212° F. for 1 to 15 minutes for protein stabilization. Fruit Wine can be made from any fruit other than grape including, but not limited to, apple, pear, citrus, tomato, blackberry, elderberry, loganberry, peach, etc. The wine is polish filtered and 0.45 micron filtered for microbiological stability. The total acidity is adjusted to a pH range of 3.5 to 3.8 by neutralizing the acid with alkaline compounds such as potassium carbonate. 500-600 gallons of this fruit wine is fortified with fruit wine spirits to a range of 23-23.9% alcohol v/v. The fortified fruit wine is blended with acidified non-dairy base in approximately a 50/50 ratio.

A second blend is created with 400 to 500 gallons fruit wine, proteolytically deactivated and pH adjusted as described above, 100 to 300 gallons sweeteners, 0.3 to 35.7 gallons natural and/or natural and artificial flavors, natural and/or artificial colors, and preservatives, including potassium benzoate, potassium sorbate and potassium metabisulfite and any others deemed necessary within legal limitations.

The first and second blends are combined with gentle agitation under sterile conditions. The first blend, a fortified fruit wine/acidified non-dairy base, is used at approximately 30% to 35% by volume, and the second blend, a flavored fruit wine, is used at approximately 65% to 70% by volume. The composition of the final product will have alcohol in 12.0% to 13.5% by volume; brix 17.5 to 23.0; and a pH in the range of 3.0 to 5.0.

### Example 7

### 1000 Gallon Batch of a Blender Drink Made with Fruit Wine (Other than Grape) and Acidified Dairy Base

A first blend is made by fermenting a fruit wine is fermented to less than 14% alcohol v/v, and then heat treating from 140° F. to 212° F. for 1 to 15 minutes for protein stabilization. Fruit Wine can be made from any fruit other than grape including, but not limited to, apple, pear, citrus, tomato, blackberry, elderberry, loganberry, or peach. This wine is polish filtered and 0.45 micron filtered for microbiological stability. The total acidity is adjusted to a pH range of 3.5 to 3.8 by neutralizing the acid with alkaline compounds such as potassium carbonate. 500 to 600 gallons of the fruit wine is fortified with fruit wine spirits to a range of 23% to 23.9% alcohol v/v. The fortified fruit wine is blended with acidified dairy base in approximately a 50/50 ratio.

A second blend is made by blending 400 to 500 gallons fruit wine, proteolytically deactivated and pH adjusted as described above, 100 to 300 gallons sweeteners, 0.3-35.7 gallons natural and/or natural and artificial flavors, natural and/or artificial colors, and preservatives, including potassium benzoate, potassium sorbate and potassium metabisulfite and any others necessary within legal limitations.

The first and second blends are combined with gentle agitation under sterile conditions. The first blend, a fortified fruit wine/acidified dairy base, is used at approximately 30% to 35%, and the second blend, a flavored fruit wine portion, is used at approximately 65% to 70% by volume. The composition of the final product will have alcohol in 12.0% to 3.5% by volume; brix 17.5 to 23.0; and a pH range of 3.0 to 5.0.

1. A wine-based alcoholic beverage comprising:
a stable non-foaming opaque emulsion of
at least one wine substantially free of proteolytic enzymes; and
at least one creamer in an amount sufficient to form a stable emulsion.

2. The wine-based alcoholic beverage according to claim 1, having a pH from about 3 to about 5.

3. The wine-based alcoholic beverage according to claim 1, wherein the wine has been heat treated at a temperature from about 120° F. to 250° F. for a time of about 1 minute to 2 hours.

4. The wine-based alcoholic beverage according to claim 1, wherein the creamer is at least one of a dairy creamer or a non-dairy creamer.

5. The wine-based alcoholic beverage according to claim 4, wherein the creamer comprises at least one protein.

6. The wine-based alcoholic beverage according to claim 5, further comprising pectin.

7. A spirit-based alcoholic beverage comprising:
a stable non-foaming creamy opaque emulsion of
at least one spirit;
at least one neutral-tasting protein-containing creamer in an amount sufficient to form a stable emulsion.

8. The spirit-based alcoholic based beverage according to claim 7, having a pH from about 3 to about 5.

9. The spirit-based alcoholic beverage according to claim 7, further comprising pectin.

10. A process for making creamy, opaque, wine based alcoholic beverages comprising:
(a) treating wine to substantially remove or deactivate proteolytic enzymes;
(b) forming a first blend by mixing together the treated wine and a non-foaming protein containing neutral-tasting creamer;
(c) emulsifying the mixture to form a stable, non-foaming, creamy, opaque, wine based alcoholic beverage, having a pH between about 3 and about 5.

11. The process according to claim 10, in which the wine is treated to substantially remove or deactivate proteolytic enzymes by heating to a temperature from about 120° F. to 250° F. for a time of about 1 minute and 2 hours.

12. The process according to claim 10, further comprising the steps of
(d) adding a second blend of at least one wine treated as in step (a), alcoholic spirits, and/or a fruit juice to the mixture from step (c);
(e) blending the mixture of step (d) to form a final blend; and
(f) optionally adjusting the pH to between about 3 to 5.

13. The process according to claim 12, wherein the first blend has a wine to creamer ratio of 1:1 by volume.

14. The process according to claim 12, wherein the final blend comprises 30% to 35% by volume of the first blend and 65% to 70% by volume of the second blend.

15. A process for making a spirit-based non-foaming alcoholic beverage comprising:
(a) emulsifying a first blend of at least one spirit and a sufficient amount of at least one protein-containing neutral-tasting creamer to form a stable emulsion;
(b) mixing a second blend of at least one spirit and/or flavors; and
(c) combining the first blend and the second blend in a proportion sufficient to obtain a final blend of an emulsified spirit-based alcoholic beverage.

16. The process according to claim 15, wherein the creamer further comprises pectin.

17. The process according to claim 15, further comprising a step of acidifying the second blend to obtain a final blend with a pH of about 3 to about 5.

18. The process according to claim 15, wherein the final blend comprises 30% to 35% by volume of the first blend and 65% to 70% by volume of the second blend.

19. A process for making a stable, spirit based non-foaming acidic alcoholic beverage comprising:
(a) blending a non-acidic spirit and a protein-containing non-foaming creamer;
(b) optionally adding other spirits and/or flavors;
(c) adjusting the pH of the blend to between about 3 and about 5; and
(d) emulsifying the blend,
to form a stable, spirit based non-foaming alcoholic beverage having a pH between about 3 and about 5.
